(19) United States
(12) Patent Application Publication
(10) Pub. No.: US 2012/0031850 A1
(43) Pub. Date: Feb. 9, 2012

(54) Extraction of Sulfate from Water

(76) Inventors: Kevin Smith, Houston, TX (US); Jeffrey Snider, Dallas, TX (US); Jimmy Poindexter, Spring, TX (US)

(21) Appl. No.: 13/197,441

(22) Filed: Aug. 3, 2011

Related U.S. Application Data
(60) Provisional application No. 61/370,980, filed on Aug. 5, 2010.

(51) Int. Cl. C02F 1/58; C02F 1/72; C02F 1/64; C02F 1/52

(52) U.S. Cl. 210/722; 210/723; 210/724

(57) ABSTRACT

Sulfate anions and divalent metal ions, such as magnesium, strontium and barium, in water are removed by treating the water with polyaluminum chloride, usually together with lime, to form ettringite and similar crystalline species which are readily removable by settling, filtration and the like. Iron is also removed by oxidation in a variation of the process. The process is particularly useful for treating aqueous solutions used in well treatment, where flowback fluids can provide some of the divalent metal ions necessary to form the ettringite-like materials, thus reducing the amount of lime otherwise necessary and further facilitating recycling of the fluid.

### RELATED APPLICATION

This application claims the full benefit of Provisional application 61/370,980 filed Aug. 8, 2010, which is incorporated herein in its entirety by reference.

### TECHNICAL FIELD

Sulfate anions and divalent metal ions in water are removed by treating the water with polyaluminum chloride, forming ettringite and similar crystalline species which are readily removable by settling, filtration and the like. The process is particularly useful for treating aqueous solutions used in well treatment, where flowback fluids can provide some of the divalent metal ions necessary to form the ettringite-like materials, thus reducing the amount of lime otherwise necessary and further facilitating recycling of the fluid.

### BACKGROUND OF THE INVENTION

Aqueous solutions are used for various types of well treatment in the recovery of hydrocarbons from the earth. Although sulfate is a very weak anion and therefore difficult to remove from water, it can combine with MAGNESIUM, barium, strontium and calcium in the earth formations when it is introduced through a well. Heavy metal and alkaline earth metal sulfates can readily plug the formation, frustrating efforts to remove oil or gas. This is particularly vexing in gas shale reservoirs, where the calcium, magnesium, barium and strontium are attached to clays associated with the shale, frequently without a closely associated counterion. Sulfate ions introduced to the formation are almost certain to form insoluble scale; thus even low levels of sulfate in fracturing treatments employing large volumes of water, for example, can result in significant downhole damage. Many naturally occurring and other sources of water used in hydrocarbon recovery operations contain sulfates, which it is desirable to remove before using.

Many downhole formations also harbor sulfate-reducing bacteria, such as Desulfovibrio desulfuricans, Desulfovibrio orientis, and Clostridium nigrificans. Being anaerobic, they metabolize sulfates, creating hydrogen sulfide, which is not only toxic but is notorious for causing corrosion of piping and hydrocarbon recovery equipment. In the past, bacteriocidal treatments have been proposed to combat sulfate-reducing bacteria—see Hoover U.S. Pat. No. 3,562,157 and Dria et al U.S. Pat. No. 4,507,212, for example. Where the water available for well treatment contains sulfates and there are sulfate-reducing bacteria in the formations, which is quite common, removal of the sulfate is indicated to avoid the problems presented by the predictable production of hydrogen sulfide without adding potentially undesirable microbiocidal materials.

We have observed that where water containing sulfate is pumped downhole into a gas shale reservoir, essentially no sulfate will return in the flowback water. As flowback continues, barium and strontium will continue to be seen in the flowback water while the sulfate continues to be absent, indicating that the sulfate is completely consumed by the barium and strontium in the formation; all of the sulfate remains in the form of harmful insoluble barium and strontium formation deposits. Barium and strontium can be expected to be present in the shale gas formations in quantities consistently able to consume virtually any amount of sulfate that might be present in an aqueous well treatment fluid. All of the barium and strontium sulfate thus formed will be deleterious to the operation of the well, and plug the gas flow channels in the rock and proppant pack. A practical way of limiting the amount of sulfate pumped into earth formations is needed.

Relatively high concentrations of sulfate have been removed from water by reverse osmosis and ion exchange, but these methods are not usually practical for the frequently remote locations of hydrocarbon production wells, or for other situations where the water has a relatively low sulfate content, meaning that large volumes of water must be handled to remove a given amount of sulfate. Various methods of precipitation have been used also, including barium chloride treatment, resulting in a completely inert, insoluble barium sulfate precipitate, but the barium chloride is toxic to handle, and expensive. Some other cations, such as calcium and magnesium, form products generally too soluble, which would result in undesirable quantities of free sulfate remaining in the water.

A practical method of removing sulfate from water, particularly in lower concentrations, in high volumes of water, and particularly in water used in hydrocarbon production, is needed.

### SUMMARY OF THE INVENTION

Our process removes sulfate from water by making the insoluble crystal ettringite and similar materials. We utilize a novel reagent comprising hydrated lime and polyaluminumhydroxychloride [hereafter sometimes “PAHC” or “PAC”], in water. To make ettringite, a molar ratio of calcium to aluminum of 3:1 is necessary, as will be seen from the formula of ettringite below. In an ideal version of our process, our reagent combines with sulfate anions in the treated water to form ettringite, which is removed by settling, filtration, or any other suitable method of removing solids from a solution. Ettringite has the formula

(CaO)₆(Al₂O₃)(SO₄)₃.32H₂O

Ettringite is sometimes expressed as (CaO)₃(Al₂O₃)(CaSO₄)₃.32H₂O. See, for example, Ramsay U.S. Pat. No. 6,280,630, using 3CaO.Al₂O₃.3CaSO₄.31/32H₂O.

In U.S. Pat. Nos. 5,547,588 and 7,326,400 ettringite is represented as Ca₆Al₂(SO₄)₃(OH)₁₂.26H₂O. In the '400 patent, ettringite is formed as part of a process for controlling sulfate in quicklime. It is seen that in all the various notations, the atomic ratio of calcium, aluminum and sulfur is 6:2:3. Various workers have created ettringite in the laboratory, see for example, Baudouin U.S. Pat. No. 4,002,484, beginning at line 15 of column 3:
An ettringite-formation reaction in stoichiometric proportions designates one of the following reactions: the products reacted are introduced in proportions, such as are given hereinbelow, which are the stoichiometric proportions of the reaction. According to the reaction it is desirable not to deviate by more than 20% in either direction from the stoichiometric proportions corresponding to the formation reaction according to the Invention, depending on the mixture of calcic aluminates.
Reaction (1)
CaO,Al₂O₃+2(CaO, H₂O)+3(CaSO₄,2H₂O)+24H₂O→(CaO)₃Al₂O₃, 3CaSO₄,32H₂O, (which will be designated as “ettringite”), or a mixture of 158 parts by weight (pw) monocalcic aluminate, 148 pw hydrated lime, 516 pw gypsum and 432 pw water, providing 1254 parts by weight of ettringite.
Reaction (2)
(CaO)₃Al₂O₃+3(CaSO₄,2H₂O)+26H₂O→1 ettringite; that is to say a mixture of 270 p.w. tricalcic aluminate, 516 pw gypsum and 468 pw water, giving 1254 pw ettringite.
Reaction (3)
CaO(Al₂O₃)₂+5(CaO,H₂O)+6(CaSO₄,2H₂O)+47H₂O→2 ettringite; that is to say, a mixture of 260 pw monocalcic dialuminate, 370 pw hydrated lime, 1032 pw gypsum, 846 pw water, providing 2508 pw ettringite.
Reaction (4)
12CaO,7Al₂O₃+9(CaO,H₂O)+6(CaSO₄,2H₂O)+47H₂O→7 ettringite; that is to say, 1386 pw of the aluminate indicated, 666 pw hydrated lime, 3612 p.w. gypsum and 3114 pw water, providing 8778 pw ettringite.
Reaction (5)
CaO,6Al₂O₃+17(CaO,H₂O)+18(CaSO₄,2H₂O)+139H₂O→6 ettringite; that is to say, 668 parts by weight of calcium hexa-aluminate, 1258 parts by weight of calcium hydroxide, 3096 parts by weight of gypsum, 2502 parts by weight of water, providing 7524 parts by weight of ettringite.

It is notable that each of the above five various reported reactions adds a stoichiometrically exact amount of water, but for our purposes, the water is present in abundance, as our objective is to remove the sulfate from a water solution or suspension. It is also notable that the formation of ettringite is a complex process even when using laboratory chemicals. Laboratory grade chemicals are not normally used under field conditions, and the well treatment fluids we deal with are infinitely variable. Ettringite occurs naturally, and is also the name of a family of very similar minerals, typically having one or more substitutions of polyvalent metals in place of an aluminum or calcium atom.

We have discovered that, in order to obtain a reagent effective to remove sulfate as ettringite or a similar material quickly under field conditions, it is necessary to use, as the source of aluminum, polyaluminum chloride. Sometimes known as polyaluminumhydroxychloride or aluminum chlorohydrate, this material has the general formula AlₙCl₍₃ₙ₋ₘ₎(OH)ₘ, a paradigm for which is Al₁₂Cl₁₂(OH)₂₄. The cation component may form a Keggin structure having 13 aluminum atoms: [Al₁₃O₄(OH)₂₄(H₂O)₁₂]⁷⁺, or [AlO₄Al₁₂(OH)₂₄(H₂O)₁₂]⁷⁺. We use the terms aluminum chlorohydrate, polyaluminum chloride, and polyaluminumhydroxychloride interchangeably, and may use the shorthand term PAC, which should be understood to mean any of these terms.

The polyaluminum chloride is used together with lime, also known as slaked lime or calcium hydroxide, Ca(OH)₂. The ratio of the two components will depend on conditions in the field, bearing in mind the ultimate objective is to provide conditions amenable to creating ettringite-like materials having ratios of 6Ca:2Al:3S or, more generally, 6M:2Al:2S where M is a divalent metal, predominantly Ca. The primary objective will be to remove sulfate; a secondary objective is to reduce the calcium that is present in the flowback fluid. However, the flowback fluid, and even sometimes the makeup water, may contain other alkaline earth metal ions. By alkaline earth metal ions other than (divalent) calcium, we mean divalent magnesium, barium, and strontium, all of which are commonly present to at least some extent in underground formations. Thus we may form not only ettringite, but ettringite-like materials having the formula Ca₆₋ₓMₓAl₂(SO₄)₃(OH)₁₂.26H₂O where M is one or more alkaline earth metals other than calcium and x is 0 to 4, it being understood that x need not be an integer because the product of our method may be a mixture.

Ideally for economic purposes, only polyaluminum chloride will be added, but very frequently a pH adjustment must be made. A pH of about 12 appears to be favorable for formation of ettringite using aluminum sources other than polyaluminum chloride, but our invention includes utilizing the polyaluminum chloride to enable ettringite and ettringite-like material formation at pH's as low as 9.0 as well as 11.0, 12.0 or higher. Where an adjustment of pH is made using lime, the additional calcium should be considered in the calculations of the molar ratios necessary to achieve the ideal 6:2:3 ratio mentioned above.

Generally, our invention aims at removing sulfate from makeup water used in drilling, fracturing, and other well treatments. By makeup water, we mean water which has not yet been introduced into a well but is intended for such use. But the invention also recognizes that flowback water—aqueous fluid recovered from a well after use as a well treatment fluid—will normally contain alkaline earth metals such as calcium, magnesium, barium, and strontium. To the extent that these divalent metal ions can be utilized instead of adding calcium, our invention contemplates the incorporation of them into the ettringite (and ettringite-like materials) we make, where they may substitute for up to four calcium atoms. The flowback water is therefore mixed with makeup water so the flowback water is recycled, a benefit in itself, as it reduces the quantity of water used in the well treatment fluid. The concentration of calcium and other divalent metals in the flowback fluid is factored into the calculations for polyaluminum chloride addition, to maintain the desired ratio of aluminum to divalent metal. Where the calcium and other alkaline earth metals in the flowback fluid are considered because it is mixed with the makeup fluid, the pH is advantageously adjusted, if necessary, with NaOH or KOH instead of lime.

A liquid form of our novel reagent may be made by mixing hydrated lime (also known as slaked lime or calcium hydroxide, Ca(OH)₂ and polyaluminumhydroxychloride in water. The total concentration with respect to water is not critical, as the reagent will very likely be diluted when added to the makeup water or the mixed makeup/flowback fluid. Any ratio of the two components will provide the appropriate ratio of 3Ca:1Al for combination with sulfate anion to form ettringite. An excess of either component is not detrimental either to the process of making the reagent or its use, and may even be beneficial. Calcium sulfate is less soluble in water than sodium sulfate; therefore it might be economical to make both calcium sulfate and ettringite (and/or ettringite-like materials) at the same time. A slurry is obtained by mixing the two components, accompanied by a noticeable exotherm. Water in the reagent slurry need only be enough to act as a carrier for the reaction product; even a very small amount of combined reagent in the reagent slurry will be effective to a commensurate degree. When our reagent slurry is added to the sulfate-containing water, solid ettringite is formed and may be removed easily. In addition, calcium, magnesium, and other alkaline earth metals may be removed from flowback water as will be seen below, yielding a treated water having a much reduced alkaline earth metal content as well as a much reduced sulfate content.

Alternatively, a dry mixture of PAC and slaked lime may be made and dissolved at the site of use. If this is done, all of the above guidelines about ratios and concentrations are applicable. But this method has the advantage that the ratio of ingredients can be adjusted depending on the concentration of calcium and sulfate in the fluid to be treated, including not only the composition of the makeup water but also the composition of the flowback water to be mixed with it. The PAC and lime can be added separately also.

### BRIEF DESCRIPTION OF THE DRAWINGS

FIG. 1 is an X-ray diffraction pattern of solid material obtained by treating a sulfate-containing water with aluminum chloride (AlCl₃).

FIG. 2 is an X-ray diffraction pattern of solid material obtained by treating the same sulfate-containing water as FIG. 1 under the same conditions, with polyaluminum chloride.

### DETAILED DESCRIPTION OF THE INVENTION

Our reagent can be made in the field by the simple step of mixing the two components, hydrated lime and PAC. Excesses of either of the two components are not deleterious to the formation of the reagent, but for the sake of economy we prefer to use atomic ratios of calcium to aluminum of 2.4:1 to 3.6:1, but ratios of 1:1 to 6:1 are satisfactory. Any ratio of the two components that will result in an effective reagent for making ettringite or ettringite having up to four other alkaline earth metal atoms substituted for calcium, with sulfate in the water to be treated is contemplated within our invention.

### Example 1

To demonstrate our invention, three putative reagent compositions, designated PAC/Ca, AC/Ca, and Ba/Ca/AC, were made for treating a stock solution of 2000 ppm of sodium sulfate. The percentages stated below are by weight.

Composition PAC/Ca was

| | | |
|---|---|---|
| PAC (15.6% Al) | 28.2% | 4.39% as Aluminum |
| Calcium Hydroxide | 24.3% | 13.16% as Calcium |
| (54.16% Ca) | | |
| Water | 47.5% | |
| Slurry solids | 51% | By loss in weight |
| | | measurement |

Composition AC/Ca was

| | | |
|---|---|---|
| Aluminum Chloride | 70% | 4% as Aluminum |
| (5.7% Al) | (32 Be AC Solution) | |
| Calcium Hydroxide | 22.13% | 11.97% as Calcium |
| (54.16% Ca) | | |
| Water | 7.87% | |
| Solids | 45.9% | By loss in weight |
| | | measurement |

Composition Ba/Ca/AC was

| | | |
|---|---|---|
| Barium hydroxide | 5% | |
| octahydrate | | |
| Aluminum Chloride | 70% | 4% as Aluminum |
| (5.7% Al) | (32 Be AC Solution) | |
| Calcium Hydroxide | 22.13% | 11.97% as Calcium |
| (54.16% Ca) | | |
| Water | 2.87% | |
| Solids | 45.1% | By loss in weight |
| | | measurement |

The three experimental reagent compositions were added to a stock solution of 2000 parts per million sodium sulfate to test their effectiveness at removing sulfate. Results are shown in Table 1. As will be seen, Composition PAC/Ca was far superior to the other two compositions at all levels of strength. The use of barium in composition Ba/Ca/AC did not improve the results of Composition AC/Ca enough to justify its extra expense and were not nearly as good as those of Composition PAC/Ca in any event. Samples 1, 2, 3, and 4 removed the sulfate at least partially in the form of ettringite.

TABLE 1

| | | | |
|---|---|---|---|
| Sample | Composition | Concentration | SO₄ after treatment¹ |

| | | | | |
|---|---|---|---|---|
| 1 | PAC/Ca | 0.5 g/100 g | 1106 | ppm |
| 2 | PAC/Ca | 1.0 g/100 g | 564 | ppm |
| 3 | PAC/Ca | 2.5 g/100 g | 161 | ppm |
| 4 | PAC/Ca | 5.0 g/100 g | 9 | ppm |
| 5 | AC/Ca | 0.5 g/100 g | 1560 | ppm |
| 6 | AC/Ca | 1.0 g/100 g | 1529 | ppm |
| 7 | AC/Ca | 2.5 g/100 g | 1461 | ppm |
| 8 | AC/Ca | 5.0 g/100 g | 1500 | ppm |
| 9 | Ba/Ca/AC | 0.5 g/100 g | 1497 | ppm |
| 10 | Ba/Ca/AC | 1.0 g/100 g | 1266 | ppm |
| 11 | Ba/Ca/AC | 2.0 g/100 g | 850 | ppm |
| 12 | Ba/Ca/AC | 5.0 g/100 g | 202 | ppm |
| 13 | — | none | 1668 | ppm |

¹Figures are for the sulfate content only; they do not include the sodium in the stock solution of 2000 ppm sodium sulfate.

Our effective reagent, PAC/Ca, may also be made in situ in the sulfate-containing water. That is, we may add the hydrated lime and the polyaluminum chloride separately to the water to be treated to obtain a similar result. When our reagent is made as suggested above, however, prior to addition to the sulfate-containing water, an exothermic reaction is obtained, indicating the formation of a reaction product. Accordingly, when the two reagent components are added directly to the sulfate-containing water, it is recommended that they be added in proximity to each other so as to promote the reaction and formation of the solids seen to be present in the slurried reagent. Formation of the reagent solids is not essential, however, as it appears the ettringite and/or ettringite-like materials can be formed on the separate addition of PAC and hydrated lime regardless of whether an identifiable reagent solid is formed in the treated fluid.

It should be observed from the above results that our invention is capable of reducing the sulfate content of sulfate-containing water by at least 90%.

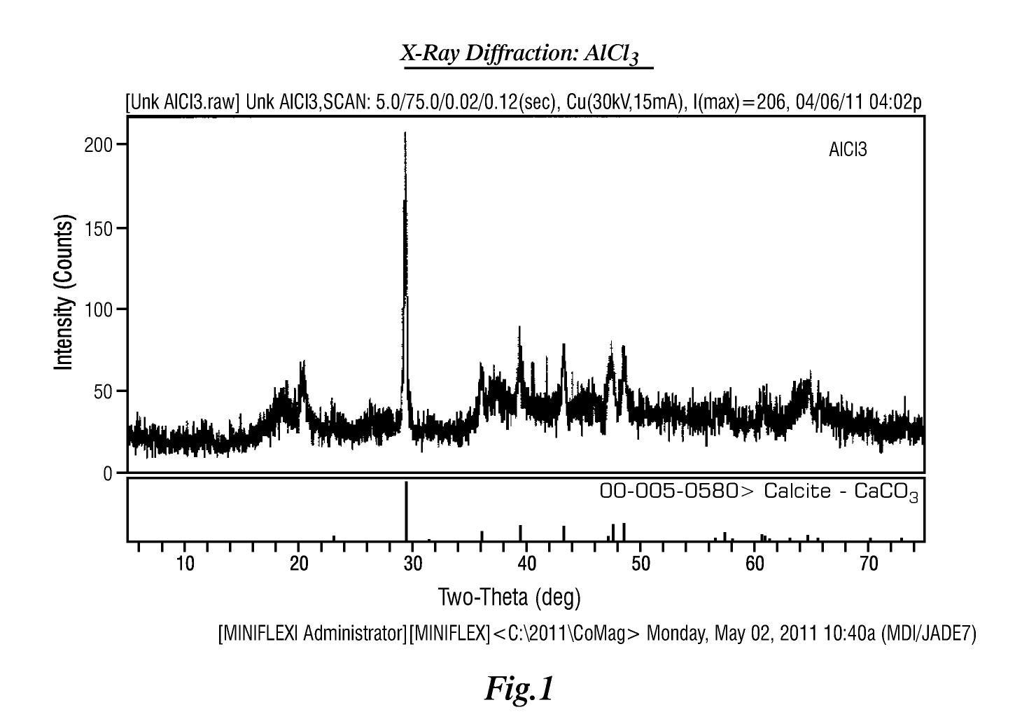

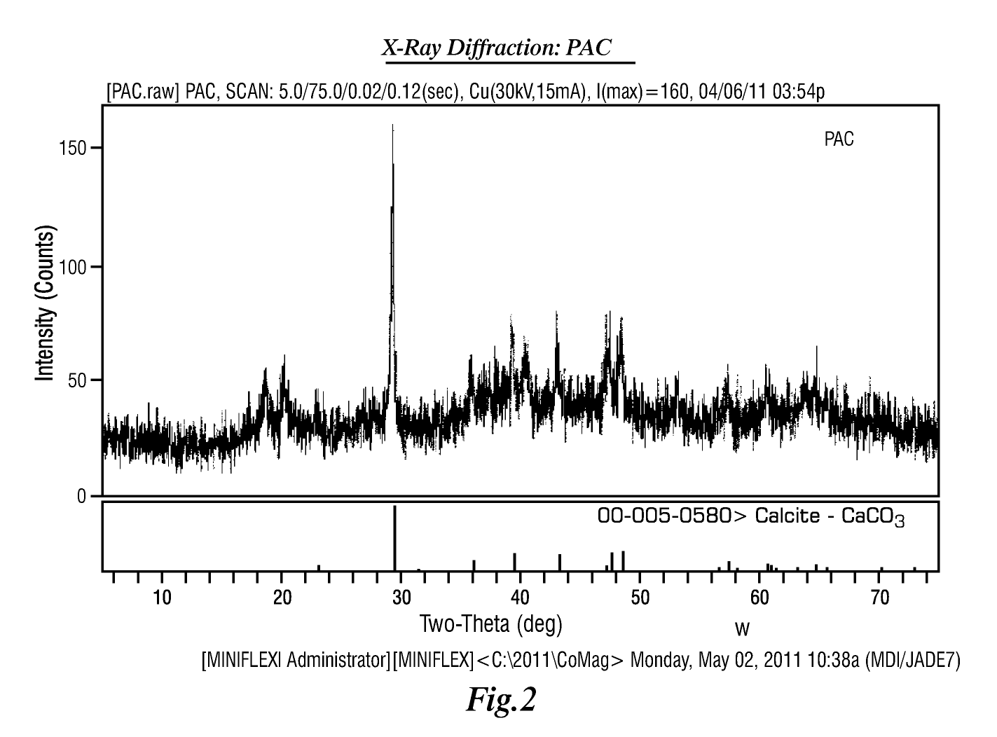

When simple aluminum chloride (AlCl₃) is substituted for the PAC in our mixing procedure, formation of ettringite is not practically effective. We are not sure why this is, but here reference is made to FIGS. 1 and 2, which are Xray diffraction patterns of solid materials obtained by treating the same sulfate-containing water under the same conditions with aluminum chloride (AlCl₃), in FIG. 1, and with polyaluminum chloride, in FIG. 2. These patterns are clearly different.

Our invention is applicable to many naturally occurring waters, but is also effective in removing sulfate from treated or partially treated waters, and various waste waters containing sulfate, such as acid mine drainage water. Our invention enables the use of acid mine drainage waters, notorious for their sulfate content among other problems, in well drilling and for other well treatment in hydrocarbon recovery. The acid mine drainage is treated by our invention to remove the sulfate and then can be employed as a well drilling or well treatment fluid with a greatly reduced risk of barium and strontium sulfate blockages in the hydrocarbon-bearing earth formations.

Where the water to be treated contains notable amounts of iron, the operator may wish to treat it with an oxidizing agent to remove the iron, which tends to interfere with the formation of calcium aluminum sulfates such as ettringite. Iron can be removed in a wide range of pH's, including a broad range well below 9.0 and above 9.0. Frequently the makeup fluid will have a pH of 6 or 7, for example. Chemical oxidizers—typically hydrogen peroxide or sodium hypochlorite—will oxidize lower valence iron compounds to higher valence iron oxides, which will precipitate. Various electrochemical and other methods can be used to oxidize and remove iron, as is known in the art; we can use any oxidizing or other method for removing iron before our method steps to remove sulfate

1. Method of treating sulfate in water to remove it therefrom comprising adding to said water containing sulfate hydrated lime and polyaluminum chloride in a ratio effective to form ettringite with said sulfate in said water.

2. Method of claim 1 wherein said ratio of hydrated lime to polyaluminum chloride provides an atomic ratio of calcium to aluminum in the range of 1:1 to 6:1, and wherein the sulfate content of said water is reduced by at least 90%.

3. Method of claim 2 wherein said ratio of hydrated lime to polyaluminum chloride provides an atomic ratio of calcium to aluminum in the range of 2.5:1 to 4:1.

4. Method of claim 1 wherein said hydrated lime and said polyaluminum chloride are in a slurry formed by adding said hydrated lime and said polyaluminum chloride to an aqueous medium.

5. Method of claim 1 including separating said ettringite from said water by filtration, centrifugation, settling, or any other suitable solid separation technique.

6. Method of claim 4 wherein said hydrated lime and said polyaluminum chloride are combined in amounts providing an atomic ratio of calcium to aluminum of 1:1 to 6:1.

7. Method of removing sulfate ions from an aqueous well treatment fluid, said well treatment fluid comprising (i) makeup water containing sulfate ions and (ii) flowback water containing alkaline earth metal ions, comprising
(a) adding to said well treatment fluid polyaluminum chloride in an amount sufficient to provide in said well treatment fluid a mole ratio of aluminum to sulfate ions of 6:3±20%, (b) adding to said well treatment fluid an amount of Ca(OH)₂ sufficient to provide, together with said alkaline earth metal ions in said flowback water, a mole ratio of alkaline earth metal ions to aluminum of 6:2±20%, thereby forming ettringite or a solid ettringite-like material containing sulfate in said well treatment fluid, and (c) removing said ettringite or ettringite-like material from said well treatment fluid.

8. Method of claim 7 wherein said alkaline earth metal ions in said flowback water comprise divalent calcium, magnesium, strontium, and barium ions.

9. Method of claim 7 wherein said ettringite or ettringite-like material has the formula Ca₆₋ₓMₓAl₂(SO₄)₃(OH)₁₂.26H₂O where M is one or more alkaline earth metals other than calcium and x is a number from 0 to 4.

10. Method of claim 7 including combining said polyaluminum chloride and said Ca(OH)₂ with water and adding them together as an aqueous slurry.

11. Method of claim 7 wherein said well treatment fluid has a pH of at least 9.0.

12. Method of claim 11 wherein said well treatment fluid is maintained at a pH of at least 11.0.

13. Method of reducing the concentration of iron and sulfate in water containing both iron and sulfate comprising (a) treating said water with an oxidizing agent to increase the oxidation state of said iron, thereby forming insoluble iron oxides (b) removing at least some of said iron in the form of said insoluble iron oxides, (c) adding to said water hydrated lime and polyaluminum chloride in amounts effective to form, with said sulfate in said water, ettringite or an ettringite-like material of the formula Ca₆₋ₓMₓAl₂(SO₄)₃(OH)₁₂.26H₂O where M is one or more alkaline earth metals other than calcium and x is a number from 0 to 4, and (d) removing at least some of said ettringite or ettringite-like material from said water.

14. Method of claim 13 including, in step (b), separating at least some of said insoluble iron oxides from said water by filtration, centrifugation, settling, or any other suitable solid separation technique.

15. Method of claim 13 including, in step (d), separating at least some of said ettringite or ettringite-like material from said water by filtration, centrifugation, settling, or any other suitable solid separation technique.

16. Method of claim 13, including, prior to step (c), adjusting the pH of said water to at least 9.0.

17. Method of claim 16 wherein the pH is adjusted to at least 11.

18. Method of claim 16 wherein the pH adjustment is made by adding sodium hydroxide or potassium hydroxide to said water.

19. Method of claim 13 wherein said water comprises acid mine drainage or a well treatment fluid.

20. Method of claim 13 wherein said oxidizing agent comprises hydrogen peroxide.
